(19) United States
(12) Patent Application Publication
(10) Pub. No.: US 2025/0220525 A1
(43) Pub. Date: Jul. 3, 2025

(54) ENHANCED MULTI-LINK SAME-CHANNEL CAPABILITY FOR SEAMLESS ROAMING

(71) Applicant: Cisco Technology, Inc., San Jose, CA (US)

(72) Inventors: Malcolm M. Smith, Richardson, TX (US); Robert E. Barton, Richmond (CA); Indermeet S. Gandhi, San Jose, CA (US); Matthew A. Silverman, Shaker Heights, OH (US); Binita Gupta, San Diego, CA (US); Brian D. Hart, Sunnyvale, CA (US)

(21) Appl. No.: 18/734,191

(22) Filed: Jun. 5, 2024

Related U.S. Application Data
(60) Provisional application No. 63/615,968, filed on Dec. 29, 2023.

(51) Int. Cl. H04W 36/00; H04L 5/00; H04W 36/18

(52) U.S. Cl. CPC H04W 36/008357; H04L 5/0053; H04W 36/18

(57) ABSTRACT

Enhanced Multi-Link Same-Channel (eMLSC) capabilities for seamless roaming may be provided. Enabling eMLSC capabilities can include provisioning a set of co-channel Multi-Link Device (MLD) Access Points (APs), including adding links of the set of co-channel MLD APs to an eMLSC domain. Next, an eMLSC seamless roaming capability is advertised. A Station (STA) requesting to use the eMLSC seamless roaming capability is associated with, and an eMLSC ID is sent to the STA. The STA may then seamless roam using the links identified by the eMLSC ID.

### RELATED APPLICATION

Under provisions of 35 U.S.C. § 119 (e), Applicant claims the benefit of and priority to U.S. Provisional Application No. 63/615,968, filed Dec. 29, 2023, the disclosure of which is incorporated herein by reference in its entirety.

### TECHNICAL FIELD

The present disclosure relates generally to Enhanced Multi-Link Same-Channel (eMLSC) capabilities for seamless roaming.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for Enhanced Multi-Link Same-Channel (eMLSC) seamless roaming;

FIG. 2 is a block diagram of an example eMLSC link configuration;

FIG. 3 is a flow chart of a method for eMLSC seamless roaming;

FIG. 4 is a flow chart of a method for utilizing eMLSC seamless roaming; and

FIG. 5 is a block diagram of a computing device.

### DETAILED DESCRIPTION

### Overview

Enhanced Multi-Link Same-Channel (eMLSC) capabilities for seamless roaming may be provided. Enabling eMLSC capabilities can include provisioning a set of co-channel Multi-Link Device (MLD) Access Points (APs), including adding links of the set of co-channel MLD APs to an eMLSC domain. Next, an eMLSC seamless roaming capability is advertised. A Station (STA) requesting to use the eMLSC seamless roaming capability is associated with, and an eMLSC ID is sent to the STA. The STA may then seamless roam using the links identified by the eMLSC ID.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Roaming in Wi-Fi occurs when a client device moves outside of the range of an Access Point (AP) or identifies other APs that can provide a better connection and connects to a new AP the client device is in range of. Ideally, a STA will be able to freely roam between multiple APs while maintaining a continuous connection to the network. For example, seamless roaming is the uninterrupted transition between APs without losing connectivity. However, existing proposed roaming techniques to enable seamless roaming have limitations, such as requiring each roam to a new Access Point (AP) to be a roam to a different channel than the roaming client was previously using. Proprietary same-channel solutions such as Virtual AP (VAP) concepts that rely on Station (STA) agnosticism (e.g., no existing preferences) have been proposed and commercialized; but, these techniques have inherent limitations.

The limitations of the current seamless roaming techniques can include scalability limitations because enabling the techniques may require either relying on dedicated radios, Multiple-Input and Multiple-Output (MIMO) chains, or Basic Service Set Identifier (BSSIDs) per STA that then follow the STA to other physical APs forming a logical AP. Another potential limitation is diagnosability because, since the STA is agnostic to the actual BSSID serving it, connectivity issues are not diagnosable from the STA side and cannot easily be correlated on the Wireless Local Area Network (WLAN) side. Mobility may be another limitation because there is no way for the STA to change to a different channel while being served by the same-channel solution. Thus, there is no way for the STA to roam to other AP groups that may provide better coverage.

Multi-Link Operation (MLO), as described by the Institute of Electrical and Electronics Engineers (IEEE) 802.11be standard for example, enables a STA to connect to multiple links simultaneously via different channels or BSSIDs. However, MLO currently requires the links to be on different channels and there is no way to implement seamless roaming on the same channel using MLO. An Enhanced Multi-Link Same-Channel (eMLSC) method for seamless roaming is described herein to address these current limitations.

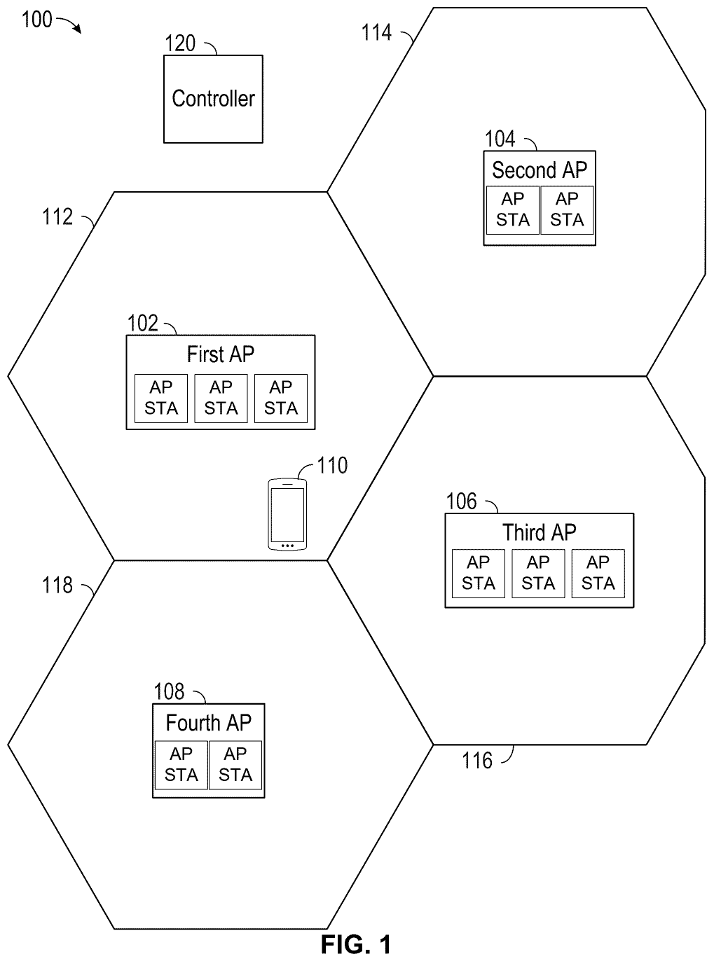

FIG. 1 is a block diagram of an operating environment 100. The operating environment 100 may include a first AP 102, a second AP 104, a third AP 106, a fourth AP 108, a STA 110, and a controller 120. The first AP 102 may have a service area or cell indicated by the first cell 112. Similarly, the second AP 104 has the second cell 114, the third AP 106 has the third cell 116, and the fourth AP 108 has the fourth cell 118. Therefore, the first AP 102, the second AP 104, the third AP 106, and the fourth AP 108 are non-collocated because each of AP corresponds to a different cell. The range of the first AP 102, the second AP 104, the third AP 106, and the fourth AP 108 may extend past the boundary of the associated cells, but the signals grow weaker. Thus, the first AP 102, the second AP 104, the third AP 106, and the fourth AP 108 may fail to communicate with devices some distance past the edges of the associated cells. The edges of the first cell 112, the second cell 114, the third cell 116, and the fourth cell 118 as shown in the operating environment 100 are an example and may be different in other examples (e.g., different sizes, shapes, etc.).

The STA 110 may be any device that connects to the network to communicate with other devices on the network, such as a smart phone, a tablet, a personal computer, a server, and/or the like. The controller 120 may be any network controller (e.g., a WLAN controller) and may manage the first AP 102, the second AP 104, the third AP 106, the fourth AP 108, and/or other network devices to allow wireless devices such as the STA 110 to connect to the network. In some embodiments, the operations of the controller 120 described herein may be performed by one or more of the first AP 102, the second AP 104, the third AP 106, the fourth AP 108, and/or another device, and vice versa. The operating environment 100 is an example configuration and there may be a different number of STAs, APs, controllers, and/or other devices in further examples.

The first AP 102, the second AP 104, the third AP 106, and the fourth AP 108 may be Multi-Link Devices (MLDs) with each including multiple AP STAs. Each AP STA may include Physical (PHY)-layer and lower-Media Access Control (MAC) components. The first AP 102, the second AP 104, the third AP 106, and the fourth AP 108 may also include an upper-MAC for coordinating the AP STAs and providing Logical Link Control (LLC).

Each AP STA may act as an AP and a single link of the respective MLD, and each AP STA of a respective AP may use a different channel. For example, the first AP 102 may include three AP STAs, with one AP STA operating on one of the channels of the 2.4 Gigahertz (GHz) band (e.g., channel one with center frequency 2.412 GHZ, channel two with center frequency 2.417 GHz. channel three with center frequency 2.422 GHZ, etc.), one AP STA operating on a channel of the 5 GHz band, and one AP STA operating on a channel of the 6 GHz band. The first AP 102, the second AP 104, the third AP 106, and the fourth AP 108 may be co-channel APs, with the respective AP STAs operating on one or more of the same channels. Clients, such as the STA 110, can link or connect to one or more AP STAs of the first AP 102, the second AP 104, the third AP 106, and the fourth AP 108.

eMLSC seamless roaming may enable the STA 110 to communicate using links the first AP 102, the second AP 104, the third AP 106, the fourth AP 108, and/or the like without needing to reassociate. To enable same channel seamless roaming, the first AP 102, the second AP 104, the third AP 106, the fourth AP 108, the controller 120, and/or other network devices may implement the eMLSC method. The network (e.g., the controller 120 and/or the APs) can create an eMLSC capable set of APs by provisioning the APs, adding the links associated with the APs (i.e., the links that are on the same channel) to the eMLSC domain, and assigning an eMLSC ID to a set of links in the eMLSC domain (i.e., an eMLSC group). The eMLSC capability can be advertised to devices (e.g., the STA 110), and the controller 120 and/or APs can enable devices to use eMLSC seamless roaming in response to a request from a device. Once an AP supporting eMLSC seamless roaming performs an association process with a device requesting to use eMLSC seamless roaming, the AP may send an eMLSC ID identifying the links supporting eMLSC seamless roaming. The device may then communicate via the links seamlessly.

Devices, such as the STA 110, may only need to communicate with one fully active Transmit (TX)/Receive (RX) radio at a time, but the devices may see within MLD the co-channel APs that are in different neighboring cells supporting eMLSC. Thus, the device can communicate using any of the links associated with the eMLSC ID, such as an AP STA of the first AP 102, an AP STA of the second AP 104, an AP STA of the third AP 106, and/or an AP STA of the fourth AP 108 at any time to seamlessly roam. In some embodiments, the devices can also be provided a list of available links based on signal strength at the device's current location, and the device can determine which link to use based on the list.

Implementing eMLSC seamless roaming may include provisioning a set of co-channel MLD APs using multiple BSSIDs on the same channel. For example, the controller 120 may provision the first AP 102, the second AP 104, the third AP 106, and the fourth AP 108 with compatible PHY configurations on the same channel(s) and assign an eMLSC ID to the APs supporting eMLSC seamless roaming on each channel. The eMLSC ID may be a logical device identifier that is expressed logically by the associated devices' software.

The controller 120, with the first AP 102, the second AP 104, the third AP 106, and the fourth AP 108, may also provision Link IDs to BSSIDs (i.e., identifying the AP STAs) associated with the logical eMLSC IDs using enhanced MLD link add procedures, as described by the Institute of Electrical and Electronics Engineers (IEEE) 802.11be standard for example, and/or the like. The Link IDs can be provisioned for the AP the STA 110 is currently connected to (e.g., the first AP 102) and for any co-channel MLD APs (e.g., the second AP 104, the third AP 106, and the fourth AP 108). Because the APs and AP STAs can be uniquely identified via the link IDs and associated BSSIDs, connection issues may be diagnosable. For example the AP, AP STA, and/or other device that is associated with a connection issue can be identified using the BSSIDs and link IDs.

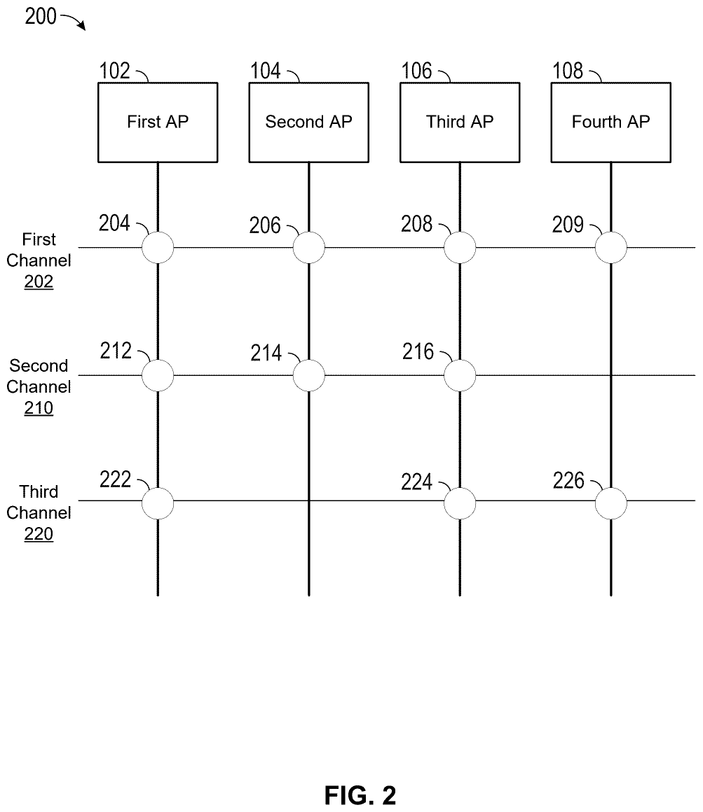

FIG. 2 is a block diagram of an example eMLSC link configuration 200. The eMLSC link configuration 200 may include the first AP 102, the second AP 104, the third AP 106, the fourth AP 108, a first channel 202, a second channel 210, and a third channel 220. The first channel 202 may include a first link 204 associated with the first AP 102, a second link 206 associated with the second AP 104, a third link 208 associated with the third AP 106, and a fourth link 209 associated with the fourth AP 108. The second channel 210 may include a fifth link 212 associated with the first AP 102, a sixth link 214 associated with the second AP 104, and a seventh link 216 associated with the third AP 106. The third channel 220 may include an eighth link 222 associated with the first AP 102, a ninth link 224 associated with the third AP 106, and a tenth link 226 associated with the fourth AP 108. There may be a different number of APs, channels, links, and/or the like in other examples.

eMLSC IDs may identify the first channel 202, the second channel 210, and the third channel 220. For example, the eMLSC ID for the first channel 202 may identify the first link 204, the second link 206, the third link 208, and the fourth link 209. The first link 204, the second link 206, the third link 208, the fourth link 209, the fifth link 212, the sixth link 214, the seventh link 216, the eighth link 222, the ninth link 224, and the tenth link 226 may each have a BSSID identifying the respective AP STA of the link and a link ID. The link IDs may be provisioned to identify the BSSIDs of each link.

An AP MLD (e.g., the first AP 102, the second AP 104, the third AP 106, and the fourth AP 108) of the controller 120 can add links (e.g., the first link 204, the second link 206, the third link 208, and the fourth link 209. The first link 204, the second link 206, the third link 208, the fourth link 209, the fifth link 212, the sixth link 214, the seventh link 216, the eighth link 222, the ninth link 224, the tenth link 226) to the eMLSC domain, or otherwise enable the links for use with eMLSC seamless roaming, if the associated link has eMLSC capability. eMLSC capability can include having the same association domain as the AP creating the eMLSC group or the association domain the controller 120 defines, authentication-less and association-less roaming, and/or the like. An eMLSC capable link may have the same or sufficiently similar integrations, data rates, capabilities, and/or the like for example. Thus, an eMLSC capable link may be a link the STA 110 does not need to perform any additional link establishment procedures to connect to.

Existing Many Make-Before-Break-Roaming (MBBR) techniques describe identifying and links for seamless roaming on different channels, and the same techniques may be implemented to identify and add eMLSC links on the same channel. For example, the MBBR techniques can include performing MLD classification to identify the type(s) of MLDs, frequency bands supported by the MLDs, the capabilities, the integrations, the data rates, and/or the like. In some embodiments, if a candidate link is compatible, the controller 120, the first AP 102, the second AP 104, the third AP 106, and/or the fourth AP 108 can add the link to the eMLSC domain using existing mechanisms such as add link notification, add link request, add link procedure, and/or the like as described by the IEEE 802.11be standard.

An AP supporting eMLSC seamless roaming can advertise the eMLSC capability to devices, such as the STA 110. A device can then request to use the eMLSC capability when associating with the AP. The AP may explicitly convey the eMLSC ID to the device upon association. For example, the first AP 102, the second AP 104, the third AP 106, and the fourth AP 108 may advertise the eMLSC capability via period frames (e.g., management frames, beacon frames), and the STA 110 may determine to associate with the first AP 102. As the STA 110 associates with the first AP 102, the STA 110 may request to use eMLSC seamless roaming. The first AP 102 may enable eMLSC seamless roaming for the STA 110 and convey the eMLSC ID(s) to the STA 110 once association is complete.

When the STA 110 is connected to the network with eMLSC seamless roaming enabled, the STA 110 may treat each BSSID of the links associated with an eMLSC ID as a distinct MLD link having an independent state, for example like power save and Target-Wake-Time (TWT) scheduling. The STA 110 can transmit (e.g., MAC Protocol Data Units (MPDUs)) on any BSSID link under the eMLSC ID. The STA 110 may select or be assigned a link to use based on signal strength conditions, as indicated by the Received Signal Strength Indicator (RSSI), beacon reports, probes, and/or the like associated with the links. In some embodiments, the STA 110 will transmit to multiple AP STAs, so the APs may receive duplicate transmissions from the STA 110. The APs may eliminate duplicate transmissions, for example at a MAC Service AP (SAP). The APs can also transmit on multiple links to the STA 110. The STA 110 may accept the first non-duplicate transmission the STA 110 receives and respond with an Acknowledge (ACK). In some example implementations, simultaneous transmissions over multiple links may be disabled via configuration or signaling to prevent collisions.

In some embodiments, the controller 120, the first AP 102, the second AP 104, the third AP 106, and the fourth AP 108 may determine to scale to different channels. For example, the controller 120 or the first AP 102 can create a new eMLSC ID for a new channel, remove link IDs on the old channel, and/or add link IDs on the new channel (e.g., using enhanced MLD link add/remove procedures as described by the 802.11be). Thus, the old eMLSC ID and the new eMLSC ID may both be used, enabling eMLSC seamless roaming to scale. For execution of an inter-channel roam, techniques like TID-to-link mapping (T2LM) can be moved to shift STA traffic.

In some embodiments, a link can be added to an eMLSC group (i.e., eMLSC ID) when the link can receive from the STA 110 on the same channel as the eMLSC. The controller 120 and/or the AP associated with the link can identify the link's ability to receive from the STA 110 on the channel and subsequently add the link to the eMLSC group. In some embodiments, the link can be added to the eMLSC group after transmissions (e.g., MPDUs) are decoded, enhancing reliability during fast mobility. The network devices may add links that can receive from the STA 110 to maintain the user experience and maintain the benefits of distinct BSSIDs known to the STA 110 while providing seamless roaming on the same channel.

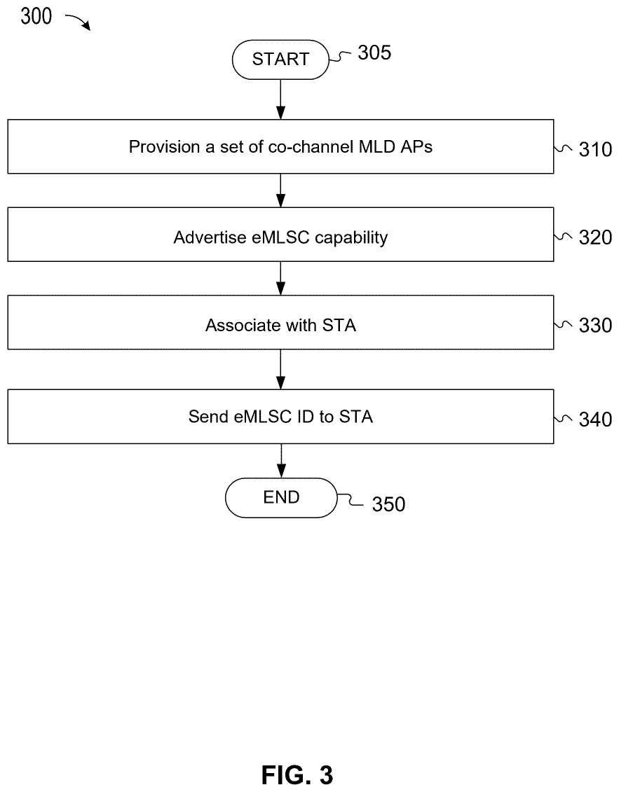

FIG. 3 is a flow chart of a method 300 for eMLSC seamless roaming. The method 300 may begin at starting block 305 and proceed to operation 310. In operation 310, a set of co-channel MLD Access Points are provisioned. For example, the controller 120 or one of the APs provisions the first AP 102, the second AP 104, the third AP 106, and the fourth AP 108, including adding links on a same channel of the set of co-channel MLD APs to an eMLSC domain. The provisioning can also include provisioning link IDs to Basic Service Set Identifiers associated with the links and identifying the plurality of links are eMLSC capable. The set of co-channel MLD APs may have compatible Physical (PHY) configurations on the same channel to be provisioned for providing eMLSC seamless roaming.

In operation 320, an eMLSC seamless roaming capability is advertised. For example, the first AP 102, the second AP 104, the third AP 106, and/or the fourth AP 108 advertise the eMLSC seamless roaming capability. The advertising may include periodically transmitting beacons indicating the eMLSC seamless roaming capability.

In operation 330, an association process is performed with an STA requesting to use the eMLSC seamless roaming capability. For example, the first AP 102 and the STA 110 perform an association, and the STA 110 requests to use the eMLSC seamless roaming capability. The association process can include the STA 110 scanning (e.g., sending a probe request), the first AP 102 replying (e.g., sending a probe response, authentication, and association.

In operation 340, an eMLSC ID is sent to the STA. For example, the first AP 102 sends the eMLSC ID to the STA 110. The eMLSC ID may identify the plurality of links in the eMLSC domain. The STA 110 is then operable to seamlessly roam between the plurality of links using the eMLSC ID.

In some embodiments, duplicate transmissions may be received from the STA 110 on the plurality of links. The one or more duplicate transmissions may be eliminated, for example by a MAC SAP. In some embodiments, a plurality of same transmissions may be sent on multiple links to the STA 110. The STA 110 may receive the same transmissions, accept the first received transmission of the same transmissions, and send an ACK response.

In some examples, a new eMLSC ID is created for a new channel (e.g., an AP not yet added to the eMLSC ID). One or more new links are added to the new eMLSC ID. Links can also be removed from the original eMLSC ID. In some embodiments, a transmission is received from the STA 110 on a new link. In response, the new link can be added to the eMLSC domain and used for eMLSC seamless roaming. The method 300 may conclude at ending block 350.

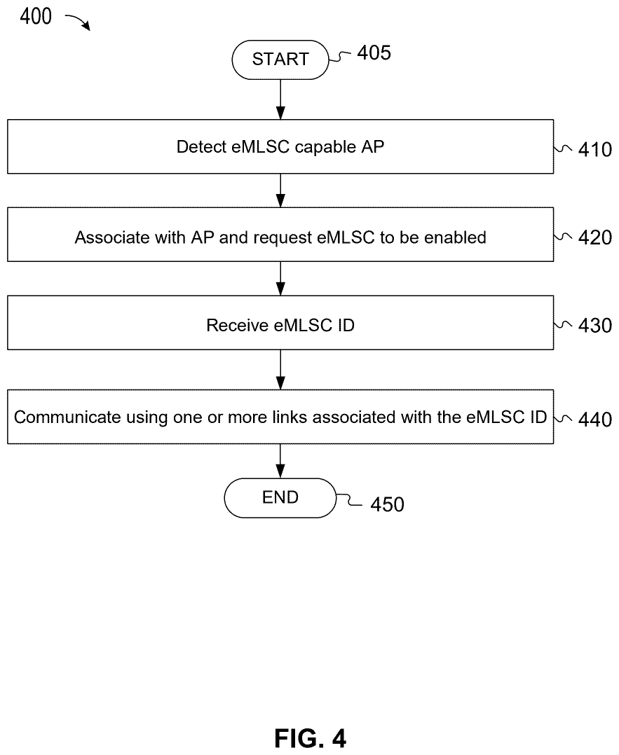

FIG. 4 is a flow chart of a method 400 for utilizing eMLSC seamless roaming. The method 400 may begin at starting block 405 and proceed to operation 410. In operation 410, an eMLSC capable AP is detected. For example, the STA 110 detects the first AP 102 and determines that the first AP 102 supports eMLSC seamless roaming. The STA 110 may detect the first AP 102 by receiving a periodic beacon indicating the support for eMLSC seamless roaming.

In operation 420, an AP is associated with a request for eMLSC seamless roaming to be enabled. For example, the STA 110 associates with the first AP 102. In operation 430, an eMLSC ID is received. For example, the STA 110 receives the eMLSC ID from the first AP 102 when association is complete.

In operation 440, one or more links associated with eMLSC ID are used to communicate. For example, the STA 110 seamlessly roams by utilizing links of the first AP 102, the second AP 104, the third AP 106, and/or the fourth AP 108 to transmit and/or receive. The method 400 may conclude at ending block 450.

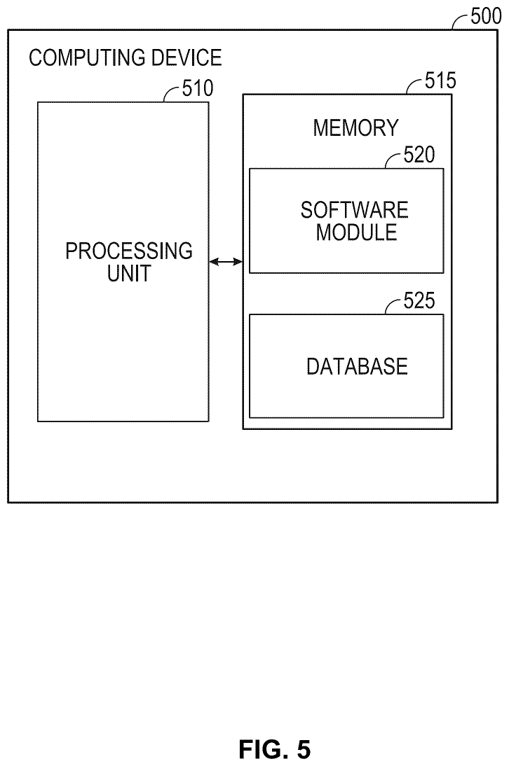

FIG. 5 is a block diagram of a computing device 500. As shown in FIG. 5, computing device 500 may include a processing unit 510 and a memory unit 515. Memory unit 515 may include a software module 520 and a database 525. While executing on processing unit 510, software module 520 may perform, for example, processes for same channel seamless roaming with respect to FIG. 1, FIG. 2, FIG. 3, and FIG. 4. Computing device 500, for example, may provide an operating environment for the first AP 102, the second AP 104, the third AP 106, the fourth AP 108, the STA 110, the controller 120, the AP STAs, and the like. The first AP 102, the second AP 104, the third AP 106, the fourth AP 108, the STA 110, the controller 120, the AP STAs, and the like may operate in other environments and are not limited to computing device 500.

Computing device 500 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 500 may comprise any computer operating environment, such as hand-held devices, multiprocessor systems, microprocessor-based or programmable sender electronic devices, minicomputers, mainframe computers, and the like. Computing device 500 may also be practiced in distributed computing environments where tasks are performed by remote processing devices. The aforementioned systems and devices are examples, and computing device 500 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general-purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 500 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
provisioning a set of co-channel Multi-Link Device (MLD) Access Points (APs), comprising adding a plurality of links on a same channel of the set of co-channel MLD APs to an Enhanced Multi-Link Same-Channel (eMLSC) domain;
advertising an eMLSC seamless roaming capability;
performing an association process with a Station (STA) requesting to use the eMLSC seamless roaming capability; and
sending an eMLSC ID to the STA, wherein the eMLSC ID identifies the plurality of links.

2. The method of claim 1, wherein the STA is operable to perform seamless roaming between the plurality of links using the eMLSC ID.

3. The method of claim 1, wherein provisioning the set of co-channel MLD APs further comprises:
provisioning link IDs to Basic Service Set Identifiers (BSSIDs) associated with each link of the plurality of links; and
identifying the plurality of links are eMLSC capable.

4. The method of claim 1, wherein the set of co-channel MLD APs have compatible Physical (PHY) configurations on the same channel.

5. The method of claim 1, further comprising:
receiving one or more duplicate transmissions from the STA on one or more links of the plurality of links; and
eliminating the one or more duplicate transmissions.

6. The method of claim 1, further comprising:
sending, to the STA, a plurality of transmissions on two or more links of the plurality of links; and
receiving an Acknowledge (ACK) response from the STA.

7. The method of claim 1, further comprising;
creating a new eMLSC ID for a new channel; and
adding one or more new links to the new eMLSC ID.

8. The method of claim 1, further comprising:
receiving a transmission from the STA on a new link; and
adding the new link to the eMLSC domain.

9. A system comprising:
a memory storage; and
a processing unit coupled to the memory storage, wherein the processing unit is operative to:
provision a set of co-channel Multi-Link Device (MLD) Access Points (APs), comprising adding a plurality of links on a same channel of the set of co-channel MLD APs to an Enhanced Multi-Link Same-Channel (eMLSC) domain;
advertise an eMLSC seamless roaming capability;
perform an association process with a Station (STA) requesting to use the eMLSC seamless roaming capability; and
send an eMLSC ID to the STA, wherein the eMLSC ID identifies the plurality of links.

10. The system of claim 9, wherein the STA is operable to perform seamless roaming between the plurality of links using the eMLSC ID.

11. The system of claim 9, wherein provisioning the set of co-channel MLD APs further comprises to:
provision link IDs to Basic Service Set Identifiers (BSSIDs) associated with each link of the plurality of links; and
identify the plurality of links are eMLSC capable.

12. The system of claim 9, wherein the set of co-channel MLD APs have compatible Physical (PHY) configurations on the same channel.

13. The system of claim 9, wherein the processing unit is further operative to:
receive one or more duplicate transmissions from the STA on one or more links of the plurality of links; and
eliminate the one or more duplicate transmissions.

14. The system of claim 9, wherein the processing unit is further operative to:
send, to the STA, a plurality of transmissions on two or more links of the plurality of links; and
receive an Acknowledge (ACK) response from the STA.

15. The system of claim 9, wherein the processing unit is further operative to:
create a new eMLSC ID for a new channel; and
add one or more new links to the new eMLSC ID.

16. A non-transitory computer-readable medium that stores a set of instructions which when executed perform a method executed by the set of instructions comprising:
provisioning a set of co-channel Multi-Link Device (MLD) Access Points (APs), comprising adding a plurality of links on a same channel of the set of co-channel MLD APs to an Enhanced Multi-Link Same-Channel (eMLSC) domain;
advertising an eMLSC seamless roaming capability;
perform an association process with a Station (STA) requesting to use the eMLSC seamless roaming capability; and
sending an eMLSC ID to the STA, wherein the eMLSC ID identifies the plurality of links.

17. The non-transitory computer-readable medium of claim 16, wherein the STA is operable to perform seamless roaming between the plurality of links using the eMLSC ID.

18. The non-transitory computer-readable medium of claim 16, wherein provisioning the set of co-channel MLD APs further comprises:
provisioning link IDs to Basic Service Set Identifiers (BSSIDs) associated with each link of the plurality of links; and
identifying the plurality of links are eMLSC capable.

19. The non-transitory computer-readable medium of claim 16, wherein the set of co-channel MLD APs have compatible Physical (PHY) configurations on the same channel.

20. The non-transitory computer-readable medium of claim 16, wherein the method executed by the set of instructions further comprises:
creating a new eMLSC ID for a new channel; and
adding one or more new links to the new eMLSC ID.
